(19) United States
(12) Patent Application Publication
(10) Pub. No.: US 2012/0023913 A1
(43) Pub. Date: Feb. 2, 2012

(54) CATALYST ABNORMALITY DIAGNOSIS APPARATUS

(75) Inventors: Mamoru Yoshioka, Susono-shi (JP); Takahiko Fujiwara, Susono-shi (JP); Ryota Onoe, Susono-shi (JP)

(73) Assignee: TOYOTA JIDOSHA KABUSHIKI KAISHA, TOYOTA-SHI, AICHI (JP)

(21) Appl. No.: 13/060,359

(22) PCT Filed: Apr. 16, 2009
(86) PCT No.: PCT/JP2009/057705

§ 371 Date: Feb. 23, 2011

(51) Int. Cl. F02D 43/00

(52) U.S. Cl. 60/285

(57) ABSTRACT

The air-fuel ratio of exhaust gas supplied to a catalyst is alternately and actively switched between a rich state value and a lean state value. In conjunction with the performance of this active air-fuel ratio control, the oxygen storage capacity of the catalyst is measured. Whether the catalyst is normal or abnormal is determined by comparing the measured value of the oxygen storage capacity with a predetermined determination value. The temperature of the catalyst is acquired, and the determination value is set based on the acquired catalyst temperature. The determination value is set so as to decreases with increasing catalyst temperature when the catalyst temperature is equal to or higher than a predetermined temperature.

### TECHNICAL FIELD

The present invention relates to abnormality diagnosis of a catalyst, and in particular, to an apparatus configured to diagnose the abnormality of a catalyst arranged in an exhaust passage in an internal combustion engine.

### BACKGROUND ART

For example, in an automotive internal combustion engine, a catalyst is installed in an exhaust system to purify exhaust gas. A certain type of such a catalyst has an oxygen storage function (O₂ storage function). The catalyst with the oxygen storage function stores excess oxygen present in exhaust gas when the air-fuel ratio of exhaust gas flowing into the catalyst is higher than a theoretical air-fuel ratio (stoichiometric value), that is, when the exhaust gas is lean. The catalyst releases oxygen when the air-fuel ratio of the exhaust gas is lower than the stoichiometric value, that is, when the exhaust gas is rich. For example, in a gasoline engine, the air-fuel ratio of the exhaust gas flowing into the catalyst is controllably set closer to the stoichiometric value. However, even if the actual air-fuel ratio deviates slightly from the stoichiometric value depending on operational conditions, the use of a ternary catalyst with the oxygen storage function allows such deviation of the air-fuel ratio to be absorbed owing to the oxygen storage and release operation of the three-element catalyst.

Degradation of the catalyst reduces the purification rate of the catalyst, and the level of degradation of the catalyst is correlated with the level of degradation of oxygen storage function. Hence, detection of degradation of oxygen storage function allows the degradation or abnormality of the catalyst to be detected. In general, a method is adopted in which the degradation of the catalyst is diagnosed by performing active air-fuel ratio control such that the air-fuel ratio is actively switched between a rich state value and a lean state value and measuring the oxygen storage capacity of the catalyst (this method is what is called a Cmax method)

Furthermore, Patent Literature 1 discloses a technique that involves measuring the time when oxygen storage reaction heat is detected at a predetermined position of the catalyst while the ternary catalyst is in a rich atmosphere and after fuel cut has been carried out, and calculating the maximum oxygen storage amount based on the detection time to determine the level of degradation of the ternary catalyst. The technique utilizes the property that the time when the storage reaction heat is detected is later as the level of degradation of the catalyst decreases. Furthermore, in view of the property that the maximum oxygen storage amount increases consistently with the floor temperature of the catalyst, the maximum oxygen storage amount is corrected based on the floor temperature of the catalyst.

### Citation List

### Patent Literature

PTL1: Japanese Patent Application Laid-Open No. 2009-13945

### SUMMARY OF INVENTION

As described above, conventional common knowledge is such that the oxygen storage capacity of the catalyst increases consistently with the catalyst temperature.

In contrast, as a result of dedicated studies, the present inventors have acquired new different knowledge. According to the new knowledge, abnormality diagnosis techniques based on the conventional common knowledge are inappropriate and may reduce the accuracy and reliability of diagnosis.

The present invention has been developed in view of these circumstances. An object of the present invention is to provide a catalyst abnormality diagnosis apparatus that adopts an appropriate diagnosis technique based on the new knowledge relating to the temperature characteristics of the catalyst, to allow the accuracy and reliability of diagnosis to be improved.

An aspect of the present invention provides an apparatus configured to diagnose abnormality of a catalyst arranged in an exhaust passage in an internal combustion engine, the apparatus being characterized by comprising:
active air-fuel ratio control means for performing active air-fuel ratio control such that an air-fuel ratio of exhaust gas supplied to the catalyst is alternately and actively switched between a rich state value and a lean state value;
measurement means for measuring an oxygen storage capacity of the catalyst in conjunction with the performance of the active air-fuel ratio control;
determination means for determining whether the catalyst is normal or abnormal by comparing a value of the oxygen storage capacity measured by the measurement means with a predetermined determination value;
catalyst temperature acquisition means for acquiring a temperature of the catalyst; and
determination value setting means for setting the determination value based on the acquired catalyst temperature acquired by the catalyst temperature acquisition means so that the determination value decreases with increasing catalyst temperature when the catalyst temperature is equal to or higher than a predetermined temperature.

As a result of dedicated studies, the present inventors have obtained knowledge contrary to the conventional knowledge; the present inventors have found that the measured value of the oxygen storage capacity decreases with increasing catalyst temperature when the catalyst temperature is high and equal to or higher than a predetermined temperature. That is, the measured value of the oxygen storage capacity initially increases gradually in proportion to the catalyst temperature. However, the oxygen storage capacity reaches the maximum value at a predetermined temperature and then a reverse phenomenon occurs; the measured value of the oxygen storage capacity decreases gradually as the temperature increases from the predetermined value. This is because the oxygen storage capacity itself of the catalyst is saturated at the predetermined temperature, while the reaction speed of the catalyst continues to increase even at the predetermined temperature or higher.

Thus, the aspect of the present invention allows the determination value to be appropriately set in accordance with the temperature characteristics based on the new knowledge. Hence, the accuracy and reliability of the diagnosis can be improved.

The “acquisition” of the catalyst temperature includes “detection” and “estimation”.

Preferably, the determination value setting means sets the determination value in accordance with a predefined relationship between the catalyst temperature and the determination value. Thus, the determination value can be relatively easily set utilizing a predefined map or function.

Alternatively, the determination value setting means acquires a reference determination value corresponding to the acquired catalyst temperature and correctively reduces the acquired reference determination value based on the acquired catalyst temperature, in accordance with a relationship between the catalyst temperature and the determination value which relationship is predefined such that the reference determination value increases consistently with the catalyst temperature when the catalyst temperature is equal to or higher than a predetermined temperature.

Thus, whether the catalyst is normal or abnormal can be preferably determined even using the reference determination value adapted for the temperature characteristics based on the conventional knowledge.

Preferably, the measurement means measures a stored oxygen amount during lean control and a released oxygen amount during rich control as the oxygen storage capacity, and
the determination means compares a predetermined difference determination value with a difference between the stored oxygen amount and the released oxygen amount or a ratio of the stored oxygen amount to the released oxygen amount to determine whether the catalyst is normal or abnormal based on a result of the comparison.

The present inventors have also gained another knowledge that the difference between the stored oxygen amount and the released oxygen amount increases with decreasing level of degradation of the catalyst. Hence, this knowledge may also be utilized to compare the predetermined difference determination value with the difference between the stored oxygen amount and the released oxygen amount or the ratio of the stored oxygen amount to the released oxygen amount to determine whether the catalyst is normal or abnormal. Then, the accuracy and reliability of the diagnosis can be further improved.

Preferably, the determination value setting means sets the difference determination value based on the acquired catalyst temperature so that a rate of an increase indifference determination value with respect to an increase in catalyst temperature starts increasing at the predetermined temperature.

The present inventors have gained another knowledge that as the catalyst temperature increases, the released oxygen amount tends to decrease with respect to the stored oxygen amount and the difference between the stored oxygen amount and the released oxygen amount increases and that the difference is greater in a temperature region where the catalyst temperature is equal to or higher than a predetermined temperature than when the catalyst temperature is lower than the predetermined temperature. Hence, based on this yet another knowledge, the difference determination value is set such that the rate of an increase in difference determination value with respect to an increase in catalyst temperature starts increasing at the predetermined temperature. Then, the accuracy and reliability of the diagnosis can be further improved.

Preferably, the determination value setting means sets the difference determination value in accordance with a predefined relationship between the catalyst temperature and the difference determination value. Thus, the difference determination value can be relatively easily set utilizing a predefined map or function.

Another aspect of the present invention provides an apparatus configured to diagnose abnormality of a catalyst arranged in an exhaust passage in an internal combustion engine, the apparatus being characterized by comprising:
active air-fuel ratio control means for performing active air-fuel ratio control such that an air-fuel ratio of exhaust gas supplied to the catalyst is alternately and actively switched between a rich state value and a lean state value;
measurement means for measuring an oxygen storage capacity of the catalyst in conjunction with the performance of the active air-fuel ratio control;
determination means for determining whether the catalyst is normal or abnormal by comparing a value of the oxygen storage capacity measured by the measurement means with a predetermined determination value; and
catalyst temperature acquisition means for acquiring a temperature of the catalyst,
wherein the measurement means measures a stored oxygen amount during lean control and a released oxygen amount during rich control as the oxygen storage capacity, and
when the acquired catalyst temperature acquired by the catalyst temperature acquisition means is equal to or higher than a predetermined temperature, the determination means compares a measured value of the stored oxygen amount with the determination value to determine whether the catalyst is normal or abnormal.

The results of the studies carried out by the present inventors indicate that the oxygen release reaction during the rich control is affected by the catalyst temperature more significantly than the oxygen storage reaction during the lean control and that the above-described reverse phenomenon appears more distinctly during the oxygen release reaction.

According to another aspect of the present invention, when the catalyst temperature is equal to or higher than the predetermined temperature, whether the catalyst is normal or abnormal is determined using only the measured value of the stored oxygen amount and not the measured value of the released oxygen amount. Thus, the released oxygen amount, which is associated with the reverse phenomenon, can be excluded from determination targets. Then, the accuracy and reliability of diagnosis at high temperature can be improved.

Preferably, the predetermined temperature is a catalyst temperature at which the measured value of the oxygen storage capacity is greatest. Thus, the determination value and the like can be set which faithfully reflect the reverse phenomenon.

Preferably, the predetermined temperature is within a range between about 500° C. and about 650° C.

Still another aspect of the present invention provides an apparatus configured to diagnose abnormality of a catalyst arranged in an exhaust passage in an internal combustion engine, the apparatus being characterized by comprising:
active air-fuel ratio control means for performing active air-fuel ratio control such that an air-fuel ratio of exhaust gas supplied to the catalyst is alternately and actively switched between a rich state value and a lean state value;
measurement means for measuring an oxygen storage capacity of the catalyst in conjunction with the performance of the active air-fuel ratio control;
determination means for determining whether the catalyst is normal or abnormal by comparing a value of the oxygen storage capacity measured by the measurement means with a predetermined determination value;
catalyst temperature acquisition means for acquiring a temperature of the catalyst;
determination value setting means for setting a determination value based on the acquired catalyst temperature acquired by the catalyst temperature acquisition means in accordance with a relationship between the catalyst temperature and the determination value which relationship is preset such that the determination value increases consistently with the catalyst temperature when the catalyst temperature is equal to or higher than a predetermined value; and
measured value correction means for correctively increasing a measured value of an oxygen storage capacity based on the acquired catalyst temperature when the catalyst temperature is equal to or higher than a predetermined value.

The present invention adopts the appropriate diagnosis technique based on the new knowledge relating to the temperature characteristics of the catalyst, to exert the excellent effect of allowing the accuracy and reliability of diagnosis to be improved.

### BRIEF DESCRIPTION OF DRAWINGS

FIG. 1 is a schematic diagram showing the configuration of an embodiment of the present invention;

FIG. 2 is a schematic cross-sectional diagram showing the configuration of a catalyst;

FIG. 3 is a time chart of active air-fuel ratio control; FIG. 4 is a time chart which is similar to FIG. 3 and which illustrates a method for measuring an oxygen storage capacity;

FIG. 5 is a graph illustrating the output characteristics of a pre-catalyst sensor and a post-catalyst sensor;

FIG. 6 is a graph illustrating a variation in the concentration of oxygen in exhaust gas discharged from the catalyst when rich control is about to end;

FIG. 7 is a graph illustrating the relationship between a catalyst temperature To and each of a normality determination value X1 and an abnormality determination value X2 according to a first embodiment;

FIG. 8 is a flowchart illustrating a procedure for an abnormality diagnosis process according to the first embodiment;

FIG. 9 is a graph illustrating the relationship between the catalyst temperature Tc and a correction coefficient J;

FIG. 10 is a graph illustrating the relationship between the catalyst temperature To and a correction coefficient H;

FIG. 11 is a flowchart illustrating a procedure for an abnormality diagnosis process according to a second embodiment;

FIG. 12 is a graph illustrating the relationship between the relationship between the catalyst temperature Tc and each of a normality determination value Y1 and an abnormality determination value Y2 according to a third embodiment;

FIG. 13 is a flowchart illustrating a procedure for an abnormality diagnosis process according to the third embodiment;

FIG. 14 is a flowchart illustrating a procedure for an abnormality diagnosis process according to the fourth embodiment; and

FIG. 15 is a graph illustrating the relationship between the relationship between the catalyst temperature Tc and each of a storage normality determination value Z1 and an abnormality determination value Z2 according to a third embodiment.

### DESCRIPTION OF EMBODIMENTS

A preferred embodiment of the present invention will be described below with reference to the accompanying drawings.

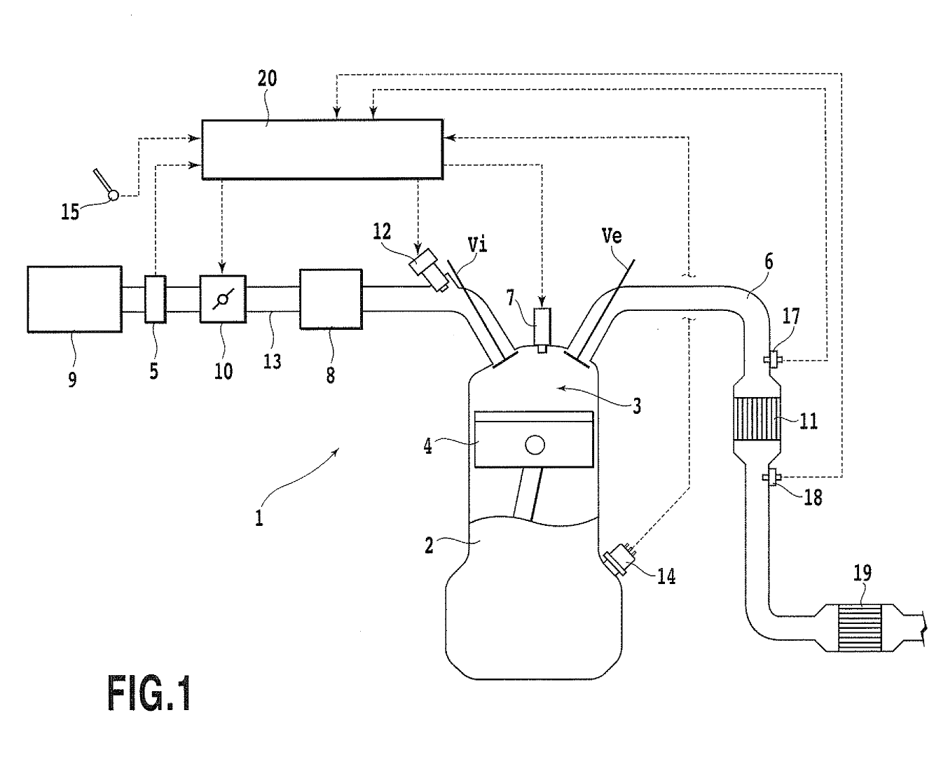

FIG. 1 is a schematic diagram showing the configuration of the present embodiment. As shown in FIG. 1, an engine 1 that is an internal combustion engine combusts an air-fuel mixture inside a combustion chamber 3 formed in a cylinder block 2 to reciprocatingly move a piston 4 in the combustion chamber 3, thus generating power. The engine 1 according to the present embodiment is an automotive multi-cylinder engine (only one cylinder is shown in the drawings), that is, a spark ignition internal combustion engine, more specifically a gasoline engine.

In a cylinder head of the engine 1, an intake valve Vi configured to open and close an intake port and an exhaust valve Ve configured to open and close an exhaust port are disposed in each cylinder. Each intake valve Vi and each exhaust valve Ve are opened and closed by a cam shaft (not shown in the drawings). Furthermore, an ignition plug 7 is attached to the top of the cylinder head for each cylinder to ignite the air-fuel mixture in the combustion chamber 3.

The intake port in each cylinder is connected, via an intake manifold, to a surge tank 8 that is an intake collection chamber. An intake pipe 13 forming an intake collection passage is connected to the upstream side of the surge tank 8. An air cleaner 9 is provided at an upstream end of the intake pipe 13. The intake pipe 13 includes an air flow meter 5 configured to detect the amount of air flowing into the engine, that is, an intake air amount, and a electrically controlled throttle valve 10; the air flow meter 5 and the throttle valve 10 are arranged in this order from the upstream side. The intake port, the intake manifold, the surge tank 8, and the intake pipe 13 form an intake passage.

An injector configured to inject fuel into the intake passage, particularly the intake port, that is, a fuel injection valve 12, is disposed in each cylinder. Fuel injected by the injector 12 is mixed with intake air to form an air-fuel mixture. The air-fuel mixture is then sucked into the combustion chamber 3 when the intake valve Vi is opened. The air-fuel mixture is further compressed by a piston 4 and ignited and combusted by the ignition plug 7.

On the other hand, the exhaust port in each cylinder is connected, via an exhaust manifold, to an exhaust pipe 6 forming an exhaust collection passage. The exhaust port, the exhaust manifold, and the exhaust pipe 6 form an exhaust passage. Catalysts each formed of a ternary catalyst with an oxygen storage function, that is, an upstream catalyst 11 and a downstream catalyst 19, are provided upstream and downstream, respectively, of the exhaust pipe 6 in series. For example, the upstream catalyst 11 is arranged immediately after the exhaust manifold. The downstream catalyst 19 is arranged under the floor of the vehicle.

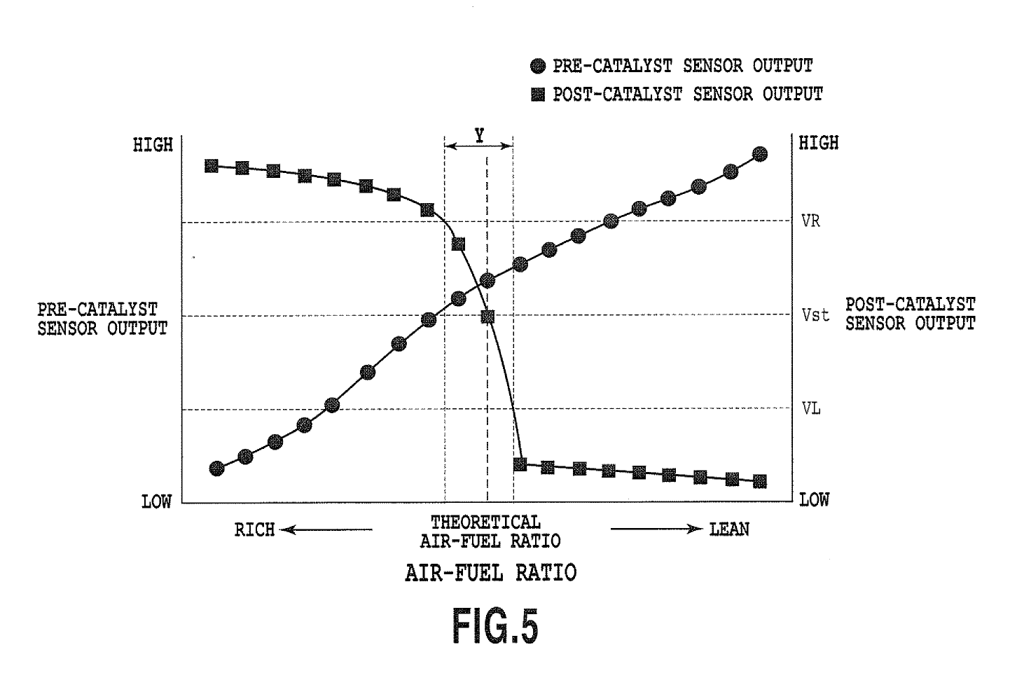

Air-fuel ratio sensors each configured to detect the air-fuel ratio of exhaust gas based on oxygen concentration, that is, a pre-catalyst sensor 17 and a post-catalyst sensor 18, are provided upstream and downstream, respectively, of the upstream catalyst 11. As shown in FIG. 5, the pre-catalyst sensor 17 is formed of what is called a wide-area air-fuel ratio sensor. The pre-catalyst sensor 17 can continuously detect the air-fuel ratio over a relatively wide range and outputs a signal with a value proportional to the air-fuel ratio. On the other hand, the post-catalyst sensor 18 is formed of what is called an O₂ sensor. The post-catalyst sensor 18 is characterized in that an output value from the post-catalyst sensor 18 starts varying rapidly at a theoretical air-fuel ratio control (this property is called the Z property)

The above-described ignition plug 7, throttle valve 10, injector 12, and the like are electrically connected to an electronic control unit (hereinafter referred to as an ECU) 20 serving as control means. The ECU 20 includes a CPU, a ROM, a RAM, an I/O port, and a storage device none of which is shown in the drawings. Furthermore, the ECU 20 not only connects electrically to the above-described air flow meter 5, pre-catalyst sensor 17, and the post-catalyst sensor 18 but also connects electrically, via an A/D converter and the like (not shown in the drawings), to a crank angle sensor 14 configured to detect the crank angle of the engine 1, an accelerator opening sensor 15 configured to detect the degree of opening of the accelerator, and various other sensors, as shown in FIG. 1. The ECU 20 controls the ignition plug 7, the injector 12, the throttle valve 10, and the like based on, for example, detected values from the various sensors so as to obtain desired output power. The ECU 20 thus controls an ignition time, a fuel injection amount, a fuel injection time, a throttle opening degree, and the like.

Each of the catalysts 11 and 19 purifies exhaust gas flowing into the catalyst to simultaneously and efficiently remove NOx, HC, and CO when the air-fuel ratio of the exhaust gas has a theoretical value (stoichiometric value, for example, A/Fs=14.6). Thus, in accordance with this property, during normal operation of the engine 1, the ECU 20 feedback-controls the air-fuel ratio of the air-fuel mixture supplied to the combustion chamber 3 based on the output from the pre-catalyst sensor 17 so that the value of the air-fuel ratio (specifically the amount of fuel injected by the injector 12) of the exhaust gas flowing into the catalyst 11 or 19 is equal to the stoichiometric value.

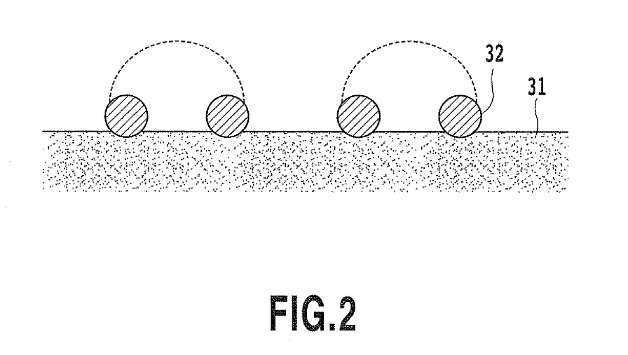

Now, the upstream catalyst 11 to be subjected to abnormality diagnosis will be described in further detail. The downstream catalyst 19 is configured similarly to the upstream catalyst 11. As shown in FIG. 2, in the catalyst 11, a coat material 31 is coated on the surface of a carrier base material (not shown in the drawings). A large number of particulate-like catalytic components 32 are carried on the coat material 31 so as to be dispersively arranged thereon. The catalytic components 32 are exposed inside the catalyst 11. The catalytic components 32 are formed mainly of rare metal such as Pt or Pd and each serve as an activation point when exhaust gas components such as NOx, HC, and CO are allowed to react. On the other hand, the coat material 31 serves as a promoter that promotes reaction at the interface between the exhaust gas and the catalytic components 32. The coat material 31 contains oxygen storage components that can absorb and release oxygen depending on the air-fuel ratio of atmosphere gas. The oxygen storage components are formed of, for example, cerium oxide CeO₂ or zirconia. The term “absorption” or “adsorption” maybe used synonymously with the term “storage”.

For example, when the air-fuel ratio of the atmosphere gas in the catalyst is lower (leaner) than the theoretical air-fuel ratio, the oxygen storage components present around the catalytic components 32 absorb oxygen from the atmosphere gas. As a result, NOx is reduced for purification. On the other hand, when the air-fuel ratio of the atmosphere gas in the catalyst is higher (richer) than the theoretical air-fuel ratio, the oxygen stored in the oxygen storage components is released. The released oxygen oxidizes HC and CO for purification.

This oxygen absorption and release action allows absorption of a possible slight deviation of the air-fuel ratio from the stoichiometric value during normal stoichiometric air-fuel ratio control.

In the unused catalyst 11, the large number of catalytic components 32 are evenly dispersively arranged as described above. In this state, the exhaust gas is very likely to contact the catalytic components 32. However, when the catalyst 11 is degraded, some of the catalytic components 32 may be lost, and others may be sintered by exhaust heat (see dashed lines in FIG. 2). Then, the exhaust gas is less likely to contact the catalytic components 32, thus reducing the purification rate. Besides, the amount of the coat material 31 present around the catalytic components 32, that is, the amount of oxygen storage components, decreases to degrade the oxygen storage function itself.

As described above, the level of degradation of the catalyst 11 is correlated with the level of degradation of the oxygen storage function. Thus, in the present embodiment, the abnormality of the upstream catalyst 11 is diagnosed by detecting the oxygen storage function of the upstream catalyst 11, which particularly significantly affects release, to detect the level of degradation of the upstream catalyst 11. Here, the oxygen storage function of the catalyst 11 is expressed by the magnitude of an oxygen storage capacity (OSC; O₂ Storage Capacity; the unit is g) that is the maximum amount of oxygen that can be stored in the current catalyst 11.

The catalyst abnormality diagnosis according to the present embodiment is based on the above-described Cmax method. During the abnormality diagnosis, the ECU 20 performs active air-fuel ratio control. That is, the ECU 20 alternately and actively switches the air-fuel ratio of exhaust gas supplied to the catalyst 11, specifically the air-fuel ratio of the air-fuel mixture in the combustion chamber 3, between a rich state value and a lean state value based on the stoichiometric value A/Fs.

Furthermore, the abnormality diagnosis is carried out during steady operation of the engine 1 and when the catalyst 11 is within an active temperature range. The temperature of the catalyst 11 (catalyst floor temperature) may be directly detected by a temperature sensor but is estimated based on the operating condition of the engine in the present embodiment. As described above, both the terms “detection” and “estimation” are included in the concept of “acquisition”.

For example, based on an intake air amount Ga detected by the air flow meter 5, the ECU 20 estimates the temperature Tc of the catalyst 11 in accordance with a predefined map or function (hereinafter referred to as the map or the like). Parameters other than the intake air amount Ga, for example, an engine rotation speed Ne, maybe used to estimate the catalyst temperature. The catalyst temperature can also be estimated using a predetermined model; the estimation method is not particularly limited.

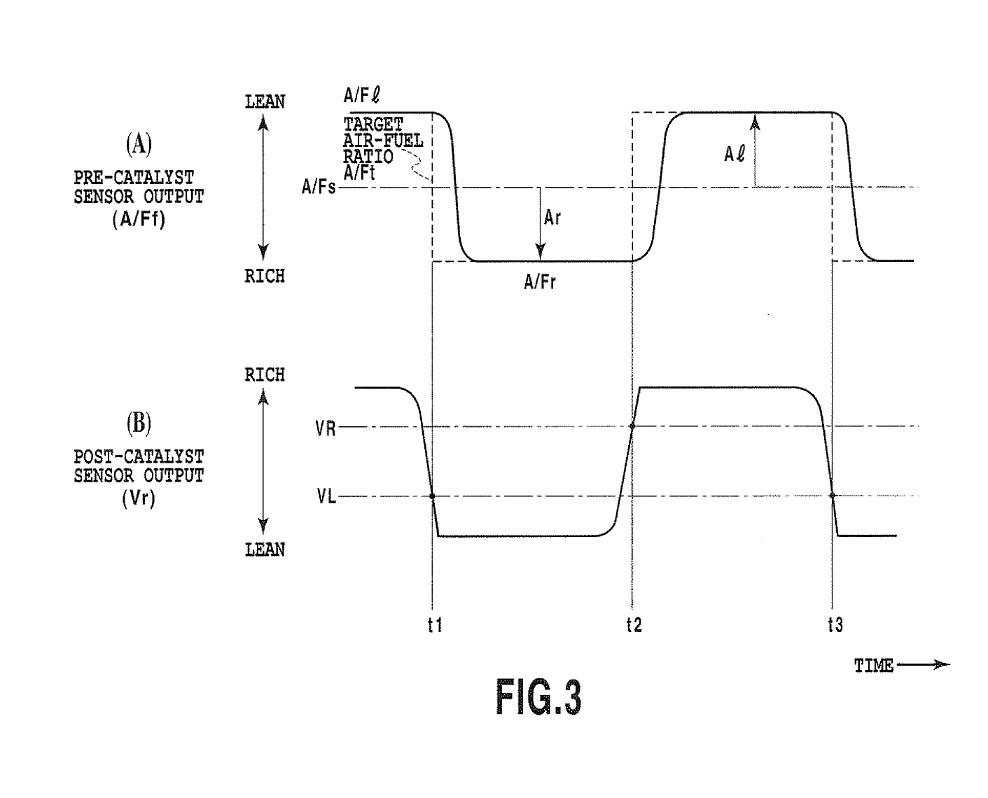

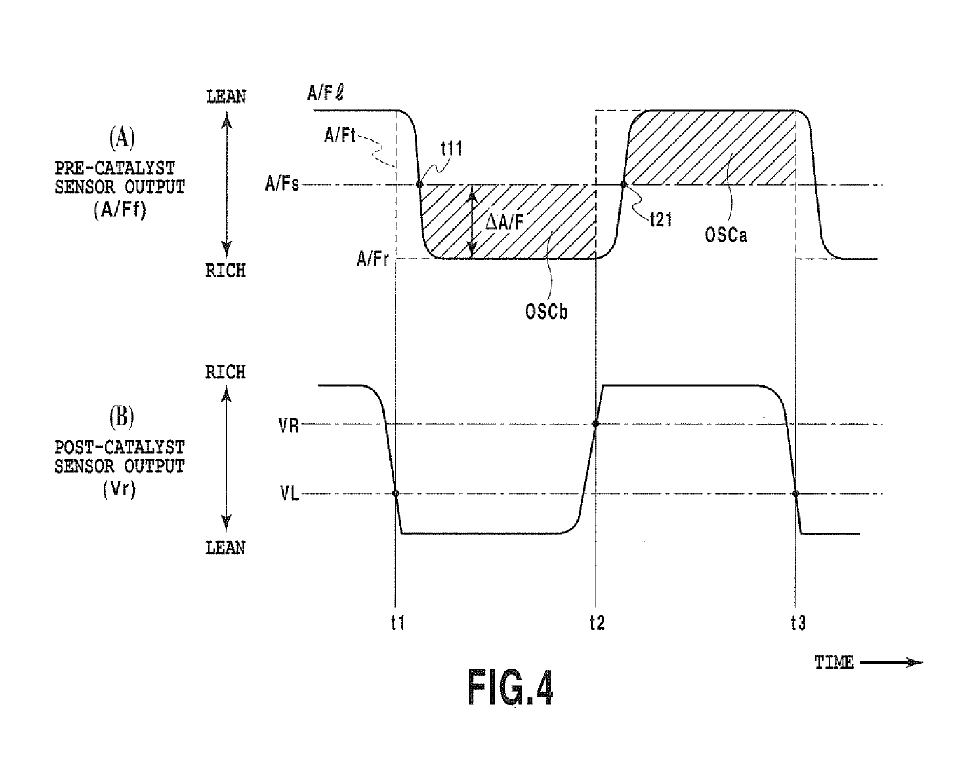

A method for measuring the oxygen storage capacity of the upstream catalyst 11 will be described below with reference to FIG. 3 and FIG. 4.

In FIG. 3(A), dashed lines indicate a target air-fuel ratio A/Ft, and solid lines indicate an output from the pre-catalyst sensor 17 (which is converted into the value of a pre-catalyst air-fuel ratio A/Ffr). Furthermore, in FIG. 3(B), solid lines indicate an output from the post-catalyst sensor 18 (an output voltage Vr from the post-catalyst sensor 18).

As shown in FIG. 3, before time t1, lean control is performed to set the target air-fuel ratio A/Ft to a lean air-fuel ratio A/Fl (for example, 15.1) so that lean gas with an air-fuel ratio equal to the target air-fuel ratio A/Ft is supplied to the catalyst 11. At this time, the catalyst 11 continues to store oxygen but can no longer store oxygen after the catalyst 11 is saturated, that is, after the catalyst 11 becomes full. As a result, the lean gas flows through the catalyst 11 to the downstream side of the catalyst 11. Then, the output from the post-catalyst sensor 18 changes to a lean side. At the time t1 when the output voltage Vr reaches a lean determination value VL (for example, 0.21 V), the target air-fuel ratio A/Ft is switched to a rich air-fuel ratio A/Fr (for example, 14.1). Thus, rich control is started to supply rich gas with an air-fuel ratio equal to the target air-fuel ratio A/Ft.

When the rich gas is supplied to the catalyst 11, the catalyst 11 continues to release the stored oxygen. In the meantime, all of the stored oxygen is released from the catalyst 11. Then, the catalyst 11 can no longer release oxygen. The rich gas flows through the catalyst 11 to the downstream side of the catalyst 11. Then, the output from the post-catalyst sensor 18 changes to a rich side. At time t2 when the output voltage Vr reaches a rich determination value VR (for example, 0.59 V), the target air-fuel ratio A/Ft is switched to a lean air-fuel ratio A/Fl. Thus, the lean control is started again to supply lean gas with an air-fuel ratio equal to the target air-fuel ratio A/Ft.

Oxygen is stored in the catalyst 11 until the catalysis 11 becomes full. When the output voltage Vr from the post-catalyst sensor 18 reaches the lean determination value VL, than at time t3, the target air-fuel ratio A/Ft is switched to the rich air-fuel ratio A/Fr. Then, the rich control is started.

Thus, every time oxygen is stored in or released from the catalyst or the output from the post-catalyst sensor 18 is inverted, the lean control and the rich control are alternately and repeatedly performed.

While the active air-fuel ratio control is being performed, the oxygen storage capacity OSC of the catalyst 11 is measured as follows.

The time for which oxygen can be continuously stored or released increases consistently with the oxygen storage capacity of the catalyst 11. That is, the inversion period (for example, the time between t1 and t2) of the post-catalyst sensor output Vr is long if the catalyst is not degraded and decreases with progression of degradation of the catalyst.

Thus, this is utilized to measure the oxygen storage capacity OSC as follows. As illustrated in FIG. 4, immediately after the target air-fuel ratio A/Ft is switched to the rich air-fuel ratio A/Fr at the time t1, the pre-catalyst air-fuel ratio A/Ff as an actual value is switched to the rich air-fuel ratio A/Fr; the switching of the pre-catalyst air-fuel ratio A/Ff is slightly later than the switching of the target air-fuel ratio A/Ft. Then, after time t11 when the pre-catalyst air-fuel ratio A/Ff reaches the stoichiometric value A/Fs and before time t2 when the next inversion occurs on the post-catalyst sensor output Vr, the oxygen storage capacity is sequentially calculated at every predetermined calculation period dOSC between time t1 and time t2 in accordance with Expression (1). In this manner, the oxygen storage capacity OSC as the final integrated value during the rich control, that is, a released oxygen amount indicated by OSCb in FIG. 4, is measured.

[Expression 1]

dOSC=ΔA/F×Q×K=|A/Ff−A/Fs|×Q×K (1)

Reference character Q denotes the fuel ejection amount. Multiplying an air-fuel ratio difference ΔA/F by the fuel injection amount Q allows calculation of an insufficient or excessive amount of air with respect to the stoichiometric value. Reference character K denotes a constant expressing the rate (about 0.23) of oxygen contained in air.

During the lean control, the oxygen storage capacity, that is, a stored oxygen amount indicated by OSCa in FIG. 4, is similarly measured. Every time the rich control and the lean control are alternately performed, the released oxygen amount and the stored oxygen amount are alternately measured.

Once a plurality of measured values are obtained for each of the released oxygen amount and the stored oxygen amount, whether the catalyst is normal or abnormal is determined as follows.

First, the ECU 20 calculates the average value OSCav of the measured values of the released oxygen amount and the stored oxygen amount. The ECU 20 then compares the average value OSCav with a predetermined determination value. The present embodiment provides two types of determination values: a normality determination value used to determine normality and an abnormality determination value used to determine abnormality. The normality determination value is greater than the abnormality determination value. The ECU 20 determines the catalyst 11 to be normal when the average value OSCav is equal to or greater than the normality determination value and to be abnormal when the average value OSCav is equal to or smaller than the abnormality determination value. The ECU 20 withholds the normality/abnormality determination when the average value OSCav is smaller than the normality determination value and greater than the abnormality determination value. Upon determining the catalyst to be abnormal, the ECU 20 preferably activates a warning device (not shown in the drawings) such as a check lamp in order to notify the user of the abnormality.

As described above, according to the conventional common knowledge, the temperature characteristics of the catalyst are such that the oxygen storage capacity of the catalyst increases consistently with the catalyst temperature. Thus, in accordance with the temperature characteristics, common methods increase the determination value consistently with the catalyst temperature.

In contrast, through dedicated studies, the present inventors have acquired new knowledge (hereinafter referred to as first knowledge) that is different from the conventional knowledge. That is, according to the new knowledge that is contrary to the conventional knowledge, after the catalyst temperature increases by at least given degrees, the measured value of the oxygen storage capacity of the catalyst decreases with increasing catalyst temperature.

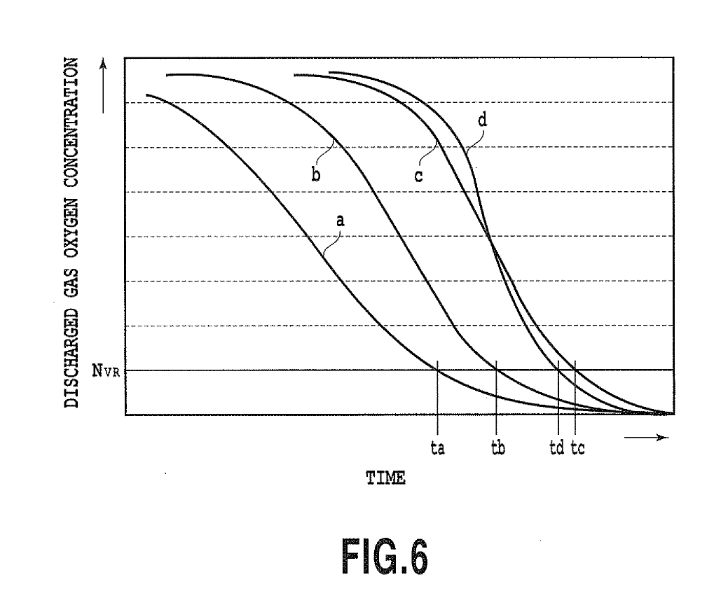

FIG. 6 is a graph illustrating how the concentration of oxygen in exhaust gas discharged by the catalyst 11 (this gas is hereinafter referred to as the discharged gas) varies when the rich control is about to end. In FIG. 6, four lines a to d are shown, each of which corresponds to a catalyst temperature, which temperatures gradually increase in order from a to d. Since the rich control is about to end, the amount of rich gas passing through the catalyst increases gradually, with the discharged gas oxygen concentration decreasing gradually. Reference character N_{VR} denotes an oxygen concentration corresponding to the rich determination value VR of the post-catalyst sensor 18. When the discharged gas oxygen concentration reaches the value N_{VR}, the output from the post-catalyst sensor 18 is inverted to the rich side. The air-fuel ratio is then switched to the lean state value. Timings when the oxygen concentration N_{VR} is reached on the lines a to d are indicated by reference characters tₐ to t_{d}, respectively.

As described above, as the inversion, to the rich side, of the output from the post-catalyst sensor takes place later, the time for which the oxygen storage capacity dOSC calculated at every calculation period is integrated increases. Thus, a great oxygen storage capacity OSC is measured. On the other hand, the oxygen concentration N_{VR} is reached later on the line (b) than on the line (a) and later on the line (c) than on the line (b). Hence, for the lines a, b, and c, the measured oxygen storage capacity OSC increases consistently with the catalyst temperature as indicated in the conventional knowledge.

However, for the lines c and d, the oxygen concentration N_{VR} is reached earlier on the line (d) than on the line (c). Thus, for the lines c and d, the measured oxygen storage capacity OSC decreases with increasing catalyst temperature unlike in the case of conventional knowledge. The catalyst temperature at which this reverse phenomenon occurs varies depending on the catalyst, but is generally within the range between about 500° C. and about 650° C. In the illustrated example, this catalyst temperature is about 500° C.

A possible reason why the reverse phenomenon occurs is as follows. That is, for the lines a, b, and c, an increase in catalyst temperature increases the activity of the catalyst and thus the oxygen storage capacity of the catalyst. At the same time, the reaction speed of the catalyst increases. Hence, the line shifts gradually rightward, with the downward inclination of the line becoming gradually steeper.

However, for the lines c and d, when the catalyst reaches a certain high temperature value, the oxygen storage capacity of the catalyst is saturated and stopped from increasing. However, the reaction speed of the catalyst further increases to make the inclination of the line further steeper.

That is, it can be assumed that an increase in oxygen storage capacity resulting from an increase in catalyst temperature is limited but that an associated increase in reaction speed is not limited. The increase in reaction speed is expected to be a main reason for the difference in the timing when the oxygen concentration N_{VR} is reached or the reverse phenomenon of the measured value of the oxygen storage capacity.

In connection with the oxygen absorption and release reaction of the catalyst, the oxygen release speed is expected to be lower than the oxygen storage speed. The reason is that in the oxygen storage reaction, oxygen is simply adsorbed by the oxygen storage components without using the catalytic components 32 formed of rare metal or the like, whereas the oxygen release reaction occurs via the catalytic components 32. Hence, the oxygen release reaction speed is significantly affected by the activity state of the catalytic components 32. The oxygen release reaction is affected by the catalyst temperature more significantly than the oxygen storage reaction. The above-described reverse phenomenon is expected to appear distinctly during the oxygen release reaction.

Based on the above discussions, the catalyst temperature is expected to be present at which the oxygen storage capacity exhibits the maximum value (this catalyst temperature is hereinafter referred to as the peak temperature) The temperature characteristics of the catalyst are such that the measured value of the oxygen storage capacity decreases as the catalyst temperature increases from the peak temperature and such that in a temperature region where the catalyst temperature is lower than the peak temperature, the measured value of the oxygen storage capacity increases consistently with the catalyst temperature. The conventional knowledge applies to the low temperature side of the peak temperature. In contrast, the present invention provides knowledge on the high temperature side of the peak temperature. The present invention also utilizes this knowledge to implement an appropriate diagnosis with high accuracy and reliability.

Embodiments relating to the abnormality diagnosis according to the above-described present embodiment will be described below. The present invention is not limited to these embodiments.

### FIRST EMBODIMENT

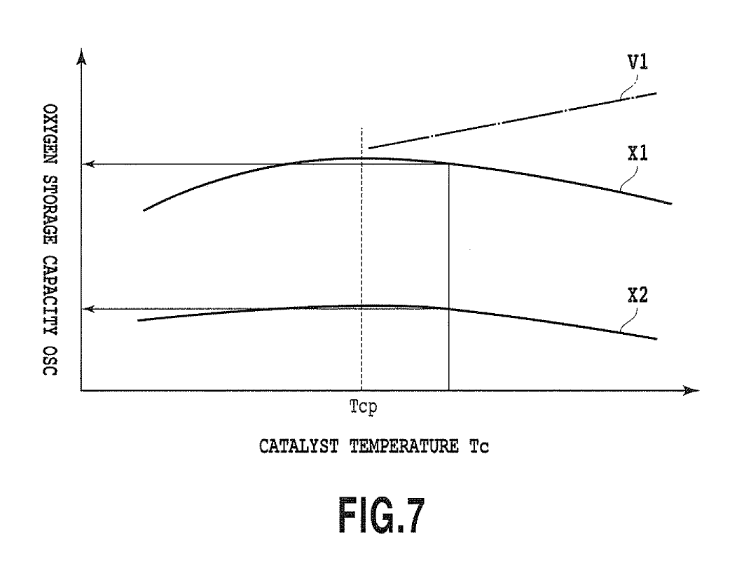

FIG. 7 illustrates the relationship between the catalyst temperature Tc and the oxygen storage capacity OSC which relationship is used in a first embodiment, more specifically, the relationship between the catalyst temperature Tc and each of a normality determination value X1 and an abnormality determination value X2 which relationship is used in the first embodiment. The relationship is pre-created based on experiments or the like in accordance with the above-described temperature characteristics and stored in the ECU 20 in the form of a map or the like. Reference character Tcp denotes the above-described peak temperature, which has a value preset based on experiments or the like. The temperature Tcp varies depending on the catalyst but is generally within the range between about 500° C. and about 650° C.

The peak temperature Tcp preferably belongs to a catalyst degraded at a predetermined level, for example, an unused, non-degraded catalyst.

As seen in FIG. 7, when the catalyst temperature

To is equal to the peak temperature Top, both the normality determination value X1 and the abnormality determination value X2 are greatest. When the catalyst temperature To is equal to or higher than the peak temperature Top, both the normality determination value X1 and the abnormality determination value X2 decrease with increasing catalyst temperature To. When the catalyst temperature To is lower than the peak temperature Top, both the normality determination value X1 and the abnormality determination value X2 increase consistently with the catalyst temperature To as is the case with the conventional techniques.

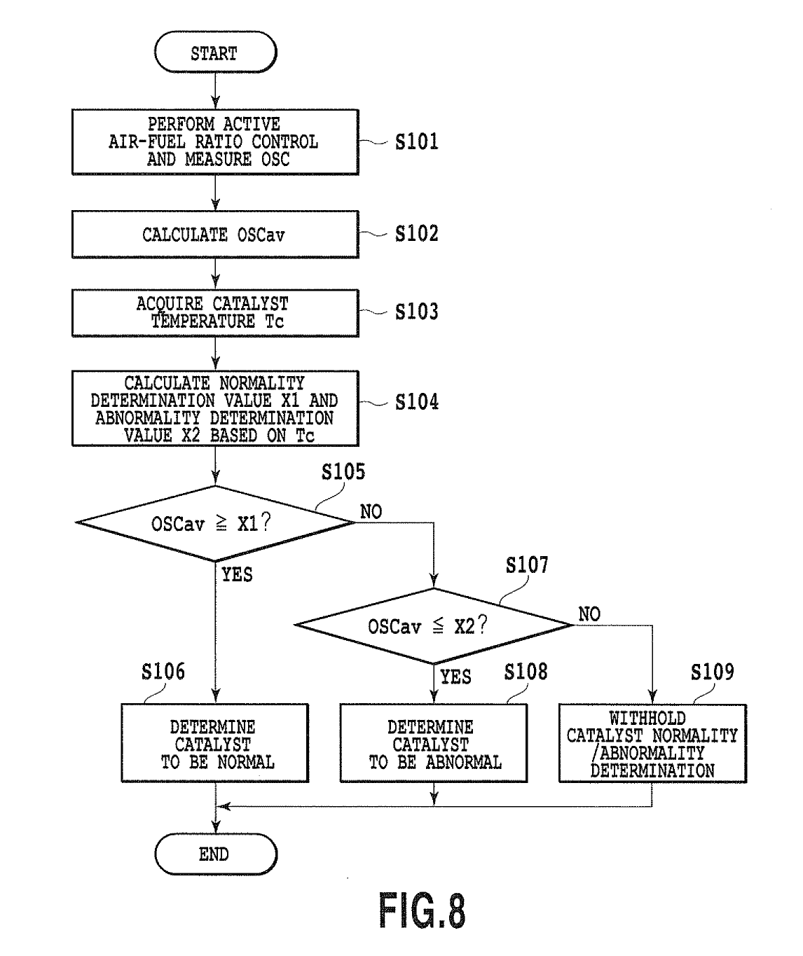

A procedure for an abnormality diagnosis process in the first embodiment carried out by the ECU 20 will be described below with reference to FIG. 8.

First, in step S101, such active air-fuel ratio control as described above is performed, and a plurality of measured values are obtained for the oxygen storage capacity USC, that is, each of the stored oxygen amount OSCa and the released oxygen amount OSCb.

Then, in step S102, the average value OSCav of the measured values of the stored oxygen amount OSCa and the released oxygen amount OSCb is calculated.

In step S103, the catalyst temperature To as an estimated value is acquired. The catalyst temperature To may be estimated at a predetermined moment or may be the average value of catalyst temperatures estimated during a predetermined period. In the present embodiment, for example, the catalyst temperature To estimated at the end of the OSC measurement is used.

In step S104, based on the catalyst temperature Tc, the normality determination value X1 and the abnormality determination value X2 are calculated in accordance with the relationship (map or the like) illustrated in FIG. 7.

In step S105, the ECU 20 compares the average value OSCav with the normality determination value X1. If OSCav≧X1, the ECU 20 proceeds to step S106 to determine the catalyst 11 to be normal. On the other hand, if OSCav<X1, the ECU 20 proceeds to step S107.

In step S107, the ECU 20 compares the average value OSCav with the abnormality determination value X2. If OSCav≦X2, the ECU 20 proceeds to step S108 to determine the catalyst 11 to be abnormal.

On the other hand, if OSCav>X2, the ECU 20 proceeds to step S109 to withhold the normality/abnormality determination for the catalyst 11.

As described above, the determination values X1 and X2 are set to decrease with increasing catalyst temperature Tc in a temperature region where the catalyst temperature Tc is equal to or higher than the peak temperature Tcp. Thus, when the actual estimated catalyst temperature Tc is high and equal to or higher than the peak temperature Tcp, the ECU 20 can compare the measured value of the oxygen storage capacity with an appropriate determination value to determine whether the catalyst is normal or abnormal. Hence, the accuracy of diagnosis in such a high temperature region can be increased, resulting in improved reliability.

Here, it is assumed that for a temperature region where the catalyst temperature Tc is equal to or higher than the peak temperature Tcp, the determination value is set as shown by a dashed line V1 in FIG. 7, in accordance with the temperature characteristics based on the conventional knowledge. Then, the determination value shifts toward the normal side, making the catalyst more likely to be determined to be abnormal. Hence, the catalyst to be determined to be normal may be determined to be abnormal, or the normality/abnormality determination may be withheld for this catalyst. However, the present embodiment allows such erroneous diagnoses to be prevented.

The determination values X1 and X2 are set to increase consistently with the catalyst temperature Tc in a temperature region where the catalyst temperature Tc is lower than the peak temperature Tcp, as indicated by the conventional knowledge. Thus, a process illustrated in FIG. 8 allows a more accurate normality/abnormality determination to be carried out even in such a temperature region.

The first embodiment can be modified as follows. That is, according to a modified method, even for the temperature region where the catalyst temperature Tc is equal to or higher than the peak temperature Tcp, a reference determination value is preset in accordance with the temperature characteristics based on the conventional knowledge. The reference determination value is corrected based on the estimated catalyst temperature to set the final determination value.

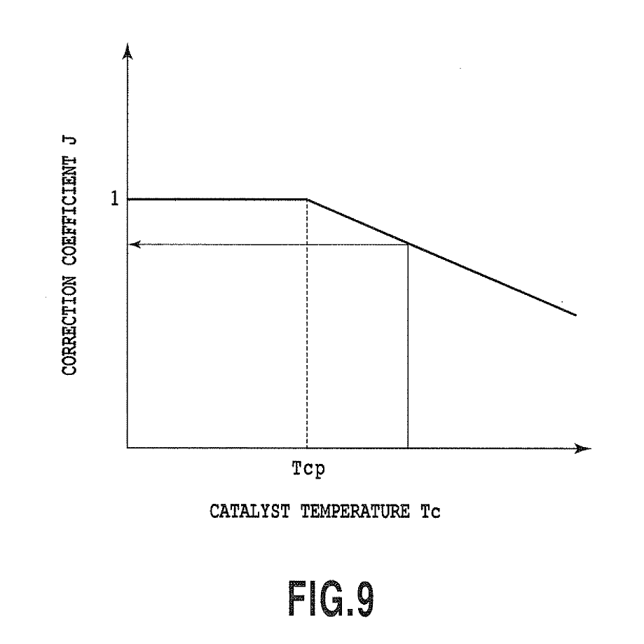

Specifically, for example, in connection with the normality determination value X1, for the temperature region where the catalyst temperature Tc is equal to or higher than the peak temperature Tcp, a reference normality determination value is preset in accordance with the temperature characteristics based on the conventional knowledge as shown by the dashed line V1 in FIG. 7. The relationship between the catalyst temperature Tc and the reference normality determination value V1 as shown in FIG. 7 is pre-stored in the ECU 20 in the form of a map or the like. Then, the reference normality determination value V1 corresponding to the estimated catalyst temperature Tc is calculated based on the map or the like. The reference normality determination value V1 is corrected based on the estimated catalyst temperature Tc. For example, a correction coefficient J corresponding to the estimated catalyst temperature Tc is calculated in accordance with the map or the like shown in FIG. 9. The reference normality determination value V1 is multiplied by the correction coefficient J. As a result, the normality determination value X1 is obtained. The correction coefficient J is preset to decrease gradually from 1 with increasing catalyst temperature Tc in the temperature region where the catalyst temperature Tc is equal to or higher than the peak temperature Tcp. Thus, the reference normality determination value V1 is correctively reduced, with the amount of correction increasing consistently with the catalyst temperature. This enables the same normality determination value as shown by X1 in FIG. 7 to be obtained.

This method also applies to the abnormality determination value X2.

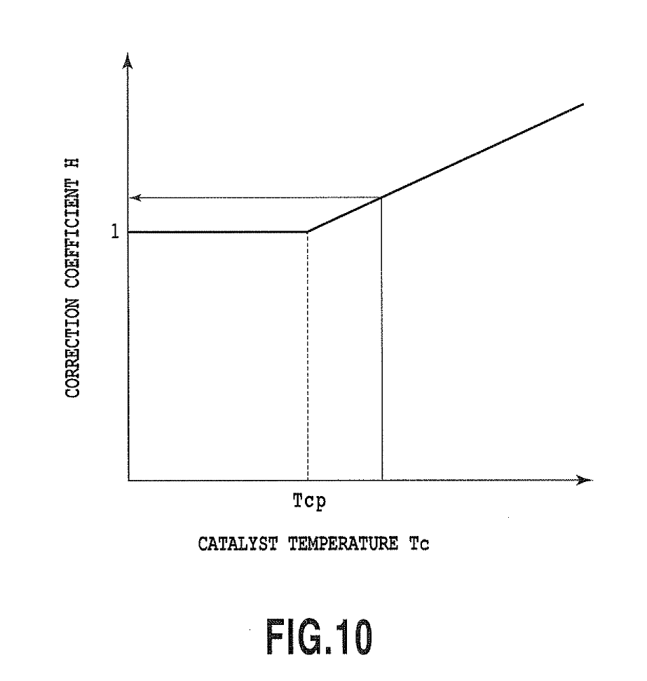

Alternatively, the following procedure is possible, though not shown in the drawings. In the temperature region where the catalyst temperature Tc is equal to or higher than the peak temperature Tcp, a determination value is used which has such characteristics as those of the reference determination value V1. Furthermore, the measured value of the oxygen storage capacity is correctively increased, and the resultant value is compared with the determination value. In this case, a correction coefficient H corresponding to the estimated catalyst temperature Tc is calculated in accordance with the map or the like as shown in FIG. 10. Then, the measured value of the oxygen storage capacity is corrected by being multiplied by the correction coefficient H. The correction coefficient H is preset to increase from 1 gradually and consistently with the catalyst temperature Tc in the temperature region where the catalyst temperature Tc is equal to or higher than the peak temperature Tcp. Thus, the measured value of the oxygen storage capacity is correctively increased, with the amount of correction increasing consistently with the catalyst temperature. Thus, even when the determination value has the characteristics based on the conventional knowledge, the measured value of the oxygen storage capacity can be corrected in accordance with the characteristics. Therefore, the appropriate normality/abnormality determination can be carried out.

### SECOND EMBODIMENT

Now, a second embodiment will be described. The second embodiment is based on another new knowledge (hereinafter referred to as second knowledge) gained by the present inventors.

That is, the present inventors have found that when the stored oxygen amount OSCa and the released oxygen amount OSCb are individually measured, the difference ΔOSC=OSCa−OSCb between the stored oxygen amount OSCa and the released oxygen amount OSCb increases with decreasing level of degradation of the catalyst, that is, increasing level of normality of the catalyst. Thus, based on the second knowledge, abnormality diagnosis is carried out as follows.

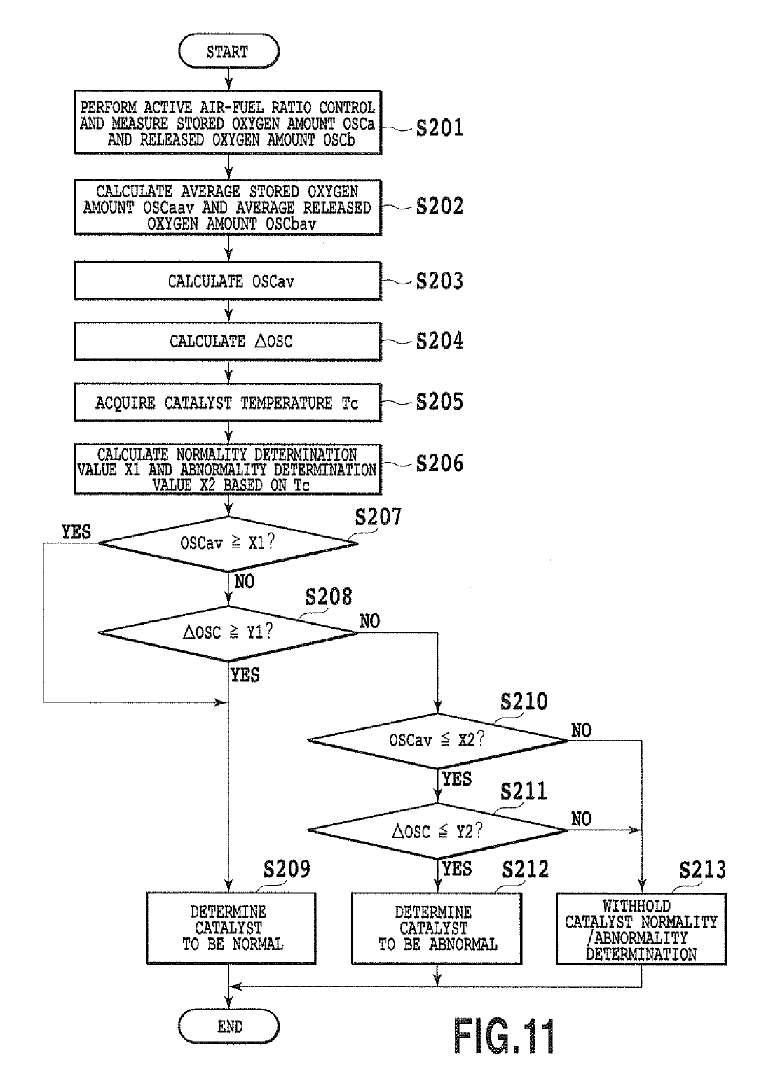

FIG. 11 illustrates a procedure for an abnormality diagnosis process in the second embodiment carried out by the ECU 20. In the illustrated example, the first embodiment is also used.

First, in step S201, the ECU 20 performs such active air-fuel ratio control as described above, and obtains a plurality of measured values of the oxygen storage capacity OSC, that is, each of the stored oxygen amount OSCa and the released oxygen amount OSCb.

Then, in step S202, the ECU 20 calculates the average value OSCav of the plurality of measured values of the stored oxygen amount OSCa, that is, an average stored oxygen amount OSCaav, and the average value of the plurality of measured values of the released oxygen amount OSCb, that is, an average released oxygen amount OSCbay.

In step S203, the ECU 20 calculates the average value OSCav of the oxygen storage capacity OSC by means of the expression OSCav=(OSCaav+OSCbav)/2.

In step S204, the ECU 20 calculates the difference ΔOSC=OSCaav−OSCbav between the average stored oxygen amount OSCaav and the average released oxygen amount OSCbay.

In step S205, the ECU 20 acquires the estimated catalyst temperature Tc as in the case of the above-described sep S103. In step S206, based on the catalyst temperature Tc, the ECU 20 calculates the normality determination value X1 and the abnormality determination value X2 as is the case with the above-described step S104.

In step S207, the ECU 20 compares the average value OSCav with the normality determination value X1 as in the above-described step S105. If OSCav≧X1, the ECU 20 proceeds to step S209 to determine the catalyst 11 to be normal. On the other hand, if OSCav<X1, the ECU 20 proceeds to step S208.

In step S107, the ECU 20 compares the difference ΔOSC with a predetermined normal difference determination value Y1. The normal difference determination value Y1 is pre-stored in the ECU 20 as a specified constant. If ΔOSC≧Y1, the ECU 20 proceeds to step S209 to determine the catalyst 11 to be normal. In this manner, even if the normality determination cannot be achieved only with the average value OSCav, the normality determination can be achieved based on the difference ΔOSC. On the other hand, if ΔOSC<Y1, the ECU 20 proceeds to step S210.

In step S210, the ECU 20 compares the average value OSCav with the abnormality determination value X2. If OSCav>X2, the ECU 20 proceeds to step S213 to withhold the normality/abnormality determination for the catalyst 11. On the other hand, if OSCav X2, the ECU 20 proceeds to step S211.

In step S211, the ECU 20 compares the difference ΔOSC with a predetermined abnormal difference determination value Y2. The abnormal difference determination value Y2 is also pre-stored in the ECU 20 as a specified constant. The value Y2 is smaller than the value Y1. If ΔOSC>Y2, the ECU 20 proceeds to step S213 to withhold the normality/abnormality determination for the catalyst 11. On the other hand, if ΔOSC Y2, the ECU 20 proceeds to step S212 to determine the catalyst 11 to be abnormal. Thus, the catalyst is determined to be abnormal when the average value OSCav and the difference ΔOSC are both smaller than the predetermined values. Hence, the accuracy of the abnormality determination can be improved.

As described above, in addition to the appropriate high-temperature-side determination values X1 and X2 according to the first embodiment, the difference ΔOSC between the stored oxygen amount OSCa and the released oxygen amount OSCb is used for the normality/abnormality determination. Therefore, the accuracy and reliability of diagnosis can be further improved.

### THIRD EMBODIMENT

Now, a third embodiment will be described. The third embodiment is based on another new knowledge (hereinafter referred to as third knowledge) gained by the present inventors.

That is, the present inventors have found that an increase in catalyst temperature tends to increase the released oxygen amount OSCb with respect to the stored oxygen amount OSCa, while increasing the difference ΔOSC. The present inventors have further found that in the temperature region where the catalyst temperature Tc is equal to or higher than the peak temperature Tcp, as a result of the above-described reverse phenomenon, the difference ΔOSC is greater than when the catalyst temperature Tc is lower than the peak temperature Tcp.

Thus, in the third embodiment, the difference determination values Y1 and Y2 are set based on the estimated catalyst temperature Tc so that the rates of increases in difference determination values Y1 and Y2 with respect to an increase in catalyst temperature Tc start increasing at the peak temperature Tcp.

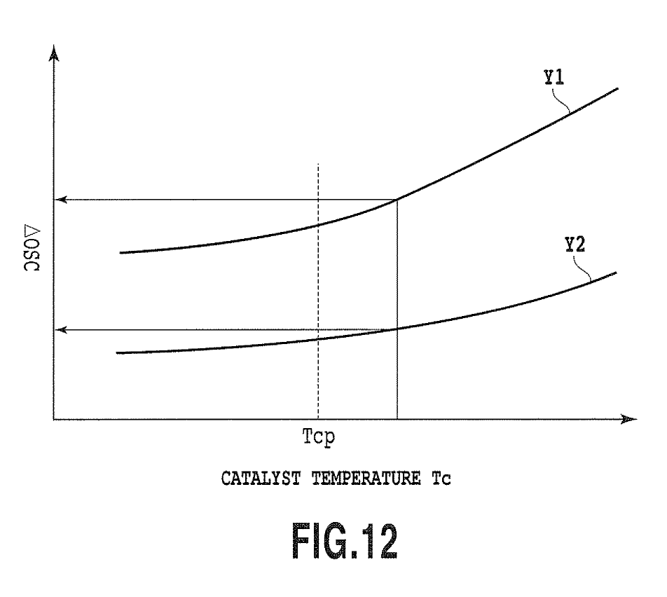

FIG. 12 illustrates the relationship between the catalyst temperature To and the difference ΔOSC which relationship is used in the third embodiment, more specifically, the relationship between the catalyst temperature Tc and each of the normality determination value Y1 and the abnormality determination value Y2 which relationship is used in the first embodiment. The relationship is experimentally pre-created based on the third knowledge and stored in the ECU 20 in the form of a map or the like. As seen in FIG. 12, the rates of increases in difference determination values Y1 and Y2 (that is, the inclinations of the lines Y1 and Y2) with respect to an increase in catalyst temperature Tc start increasing at the peak temperature Tcp. That is, the rates are higher when the catalyst temperature Tc is equal to or higher than the peak temperature Tcp than when the catalyst temperature Tc is lower than the peak temperature Tcp.

Thus, setting the difference determination values Y1 and Y2 in accordance with the relationship allows the setting of the appropriate difference determination values Y1 and Y2 in which the third knowledge is reflected. As a result, the appropriate normality/abnormality determination based on the difference ΔOSC can be carried out in all the catalyst temperature regions (particularly the region of catalyst temperatures equal to or higher than the peak temperature). Therefore, the accuracy and reliability of diagnosis can be further improved.

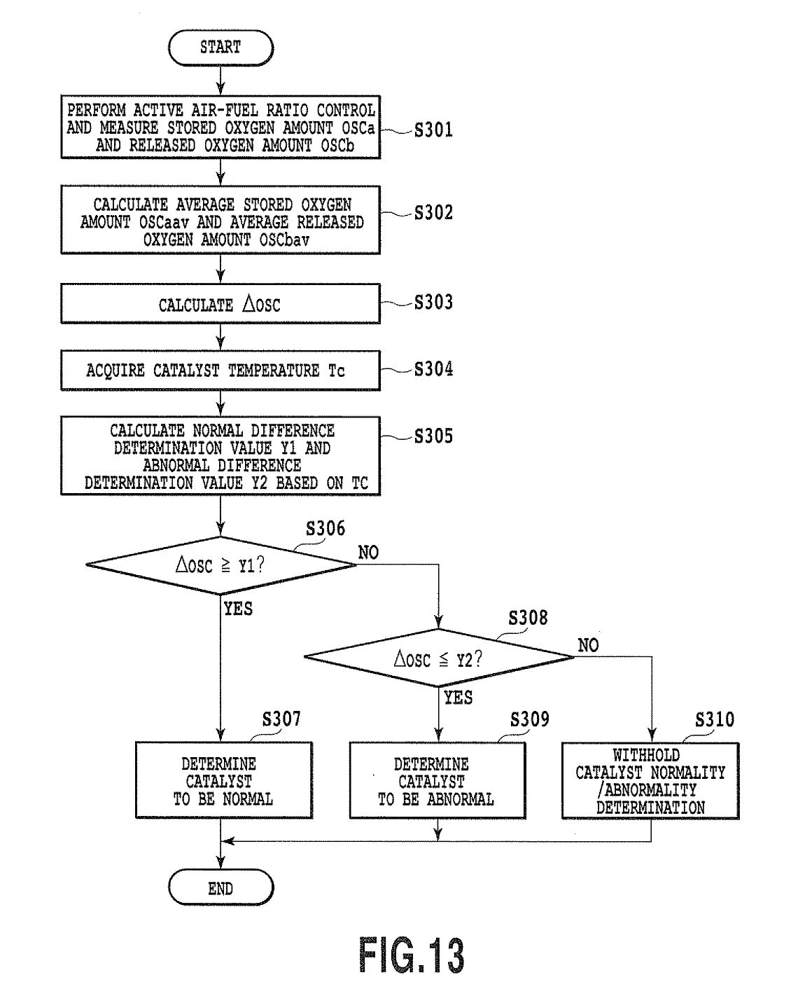

FIG. 13 illustrates a procedure for an abnormality diagnosis process in the third embodiment carried out by the ECU 20. In the illustrated example, the first embodiment is not used. However, the first embodiment may also be used as in the case of the second embodiment.

In step S301, the ECU 20 performs the active air-fuel ratio control, and obtains a plurality of measured values of the oxygen storage capacity OSC, that is, each of the stored oxygen amount OSCa and the released oxygen amount OSCb.

Then, in step S302, the ECU 20 calculates the average stored oxygen amount OSCaav and the average released oxygen amount OSCbav from the plurality of measured values of the stored oxygen amount OSCa and the plurality of measured values of the released oxygen amount OSCb, respectively.

In step S303, the ECU 20 calculates the difference ΔOSC=OSCaav−OSCbav between the average stored oxygen amount OSCaav and the average released oxygen amount OSCbay.

In step S304, the ECU 20 acquires the estimated catalyst temperature Tc as is the case with the above-described sep S103. Then, in step S305, based on the acquired catalyst temperature Tc, the ECU 20 calculates the normality determination value Y1 and the abnormality determination value Y2 in accordance with the relationship (map or the like) illustrated in FIG. 12.

In step S306, the ECU 20 compares the difference ΔOSC with the normality determination value Y1. If ΔOSC≧Y1, the ECU 20 proceeds to step S307 to determine the catalyst 11 to be normal . On the other hand, if ΔOSC<Y1, the ECU 20 proceeds to step S308.

In step S308, the ECU 20 compares the difference ΔOSC with the abnormality determination value Y2. If ΔOSC>Y2, the ECU 20 proceeds to step S309 to determine the catalyst 11 to be abnormal. On the other hand, if ΔOSC>Y1, the ECU 20 proceeds to step S310 to withhold the normality/abnormality determination for the catalyst 11.

### FOURTH EMBODIMENT

Now, a fourth embodiment will be described. As described above, the oxygen release reaction is affected by the catalyst temperature more significantly than the oxygen storage reaction. The above-described reverse phenomenon appears distinctly during the oxygen release reaction.

Thus, in the fourth embodiment, when the catalyst temperature Tc is high and equal to or higher than the peak temperature Tcp, the normality/abnormality determination is carried out using only the measured value of the stored oxygen amount OSCa and not the measured value of the released oxygen amount OSCb. Thus, the released oxygen amount OSCb, which is associated with the reverse phenomenon at high temperature, can be excluded from determination targets. Then, the accuracy and reliability of diagnosis at high temperature can be improved. Furthermore, the diagnosis itself can be simplified.

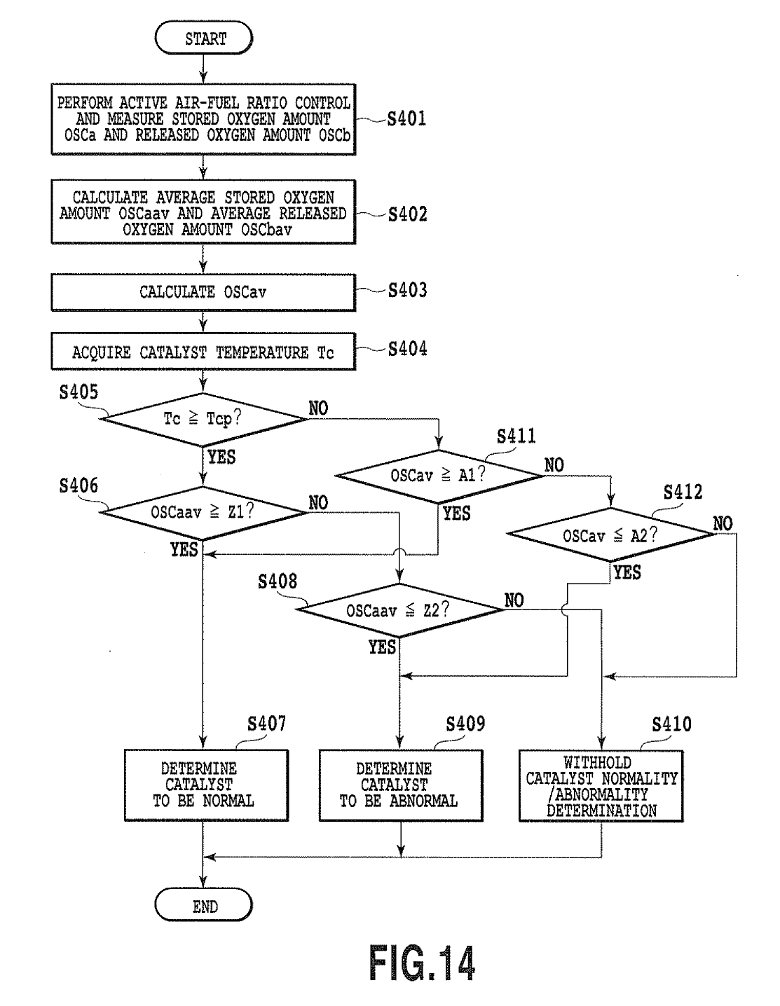

FIG. 14 illustrates a procedure for an abnormality diagnosis process in the fourth embodiment carried out by the ECU 20.

In step S401, the ECU 20 performs the active air-fuel ratio control, and obtains a plurality of measured values of the oxygen storage capacity OSC, that is, each of the stored oxygen amount OSCa and the released oxygen amount OSCb.

Then, in step S402, the ECU 20 calculates the average stored oxygen amount OSCaav and the average released oxygen amount OSCbav from the plurality of measured values of the stored oxygen amount OSCa and the plurality of measured values of the released oxygen amount OSCb, respectively.

In step S403, the ECU 20 calculates the average value OSCav of the oxygen storage capacity OSC by means of the expression OSCav=(OSCaav+OSCbav)/2.

In step S404, the ECU 20 acquires the estimated catalyst temperature Tc is acquired as is the case with the above-described step S103.

In step S405, the ECU 20 compares the acquired estimated catalyst temperature Tc with the peak temperature Tcp.

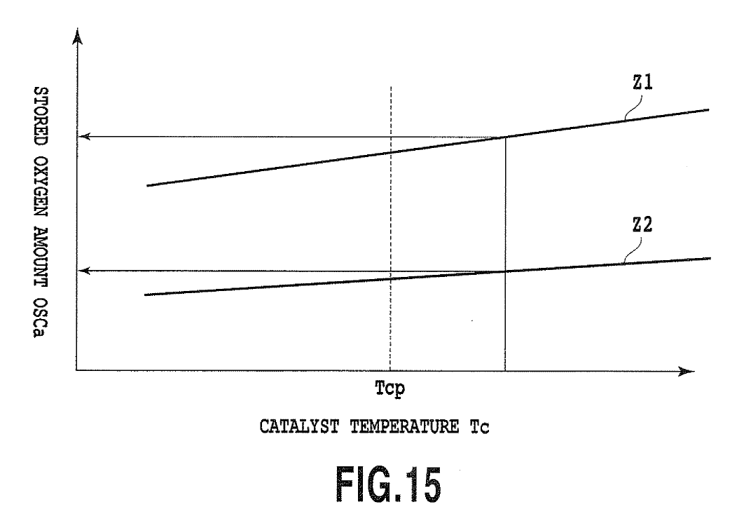

If Tc≧Tcp, the ECU 20 proceeds to step S406 to compare the average stored oxygen amount OSCaav with a predetermined storage normality determination value Z1. The storage normality determination value Z1 is calculated based on the estimated catalyst temperature Tc acquired in step S404 in accordance with such a relationship as shown in FIG. 15, that is, such a map or the like as shown in FIG. 15. As illustrated in FIG. 15, the storage normality determination value Z1 and a storage abnormality determination value Z2 are preset so as to increase consistently with the catalyst temperature Tc as indicated by the conventional knowledge, even in the region of temperatures equal to or higher than the peak temperature Tcp. This corresponds to the tendency of the stored oxygen amount OSCa to increase consistently with the catalyst temperature Tc even in the region of temperatures equal to or higher than the peak temperature Tcp.

If the result of the comparison indicates that OSCaav≧Z1, the ECU 20 proceeds to step S407 to determine the catalyst 11 to be normal. On the other hand, if the result of the comparison indicates that OSCaav<Z1, the ECU 20 proceeds to step S408.

In step S408, the ECU 20 compares the average stored oxygen amount OSCaav with the predetermined storage abnormality determination value Z2. If OSCaav≦Z2, the ECU 20 proceeds to step S409 to determine the catalyst 11 to be abnormal. On the other hand, if OSCaav>Z2, the ECU 20 proceeds to step S410 to withhold the normality/abnormality determination for the catalyst 11.

If Tc<Tcp in step S405, the ECU 20 carries out the normality/abnormality determination in accordance with the normal Cmax method. That is, first, in step S411, the ECU 20 compares the average value OSCav with a normality determination value A1. The normality determination value A1 and an abnormality determination value A2 described below are calculated based on the estimated catalyst temperature Tc acquired in step S404, in accordance with a pre-stored map or the like. The normality determination value A1 and the abnormality determination value A2 have characteristics similar to those illustrated in FIG. 15 and are preset so as to increase consistently with the catalyst temperature Tc. However, the magnitudes of the normality determination value A1 and the abnormality determination value A2 are different from those of the storage normality determination value Z1 and the storage abnormality determination value Z2, respectively. This is because the average value OSCav is obtained with the released oxygen amount OSCb also taken into account.

If OSCav≦A1, the ECU 20 proceeds to step S407 to determine the catalyst 11 to be abnormal. On the other hand, if OSCav>A1, the ECU 20 proceeds to step S412.

Instep S412, the ECU 20 compares the average value OSCav with the abnormality determination value A2. If ΔOSC≦A2, the ECU 20 proceeds to step S409 to determine the catalyst 11 to be abnormal. On the other hand, if ΔOSC>A2, the ECU 20 proceeds to step S410 to withhold the normality/abnormality determination for the catalyst 11.

The embodiment of the present invention has been described in detail. However, various other embodiments of the present invention are possible. For example, the application and form of the engine are optional. For example, the engine may be used for applications other than vehicles and may be of a direction injection engine or a compression ignition internal combustion engine. Furthermore, in the above-described embodiment provides the two types of determination values used to determine normality and abnormality, respectively. However, a single type of determination value may be used to carry out the normality/abnormality determination. Also for the oxygen storage capacity OSC, instead of the plurality of average values, a single value may be used to carry out the normality/abnormality determination. However, naturally, the plurality of average values are preferable for improved accuracy and the like. In the second and third embodiments, instead of the difference ΔOSC=OSCa−OSCb between the stored oxygen amount OSCa and the released oxygen amount OSCb, the ratio OSCa/OSCb of the stored oxygen amount OSCa to the released oxygen amount OSCb may be used. The above description is also applicable to this case.

Whether or not the catalyst temperature is equal to or higher than the peak temperature Tcp may also be determined by the following method. That is, the catalyst temperature increases consistently with the duration for which a steady operation condition with a great intake air amount (a heavy load) lasts. Hence, whether or not the catalyst temperature is equal to or higher than the peak temperature Tcp may be determined based on the duration of the steady operation and the intake air amount.

The present invention includes any modifications, applications, and equivalents embraced in the concepts of the present invention defined by the claims. Therefore, the present invention should not be interpreted in a limited manner but is applicable to any other techniques belonging to the scope of the concepts of the present invention.

1. An apparatus configured to diagnose abnormality of a catalyst arranged in an exhaust passage in an internal combustion engine, the apparatus comprising:
active air-fuel ratio control means for performing active air-fuel ratio control such that an air-fuel ratio of exhaust gas supplied to the catalyst is alternately and actively switched between a rich state value and a lean state value;
measurement means for measuring an oxygen storage capacity of the catalyst in conjunction with the performance of the active air-fuel ratio control;
determination means for determining whether the catalyst is normal or abnormal by comparing a value of the oxygen storage capacity measured by the measurement means with a predetermined determination value;
catalyst temperature acquisition means for acquiring a temperature of the catalyst; and
determination value setting means for setting the determination value based on the acquired catalyst temperature acquired by the catalyst temperature acquisition means so that the determination value decreases with increasing catalyst temperature when the catalyst temperature is equal to or higher than a predetermined temperature.

2. The catalyst abnormality diagnosis apparatus according to claim 1 wherein the determination value setting means sets the determination value in accordance with a predefined relationship between the catalyst temperature and the determination value.

3. The catalyst abnormality diagnosis apparatus according to claim 1 wherein the determination value setting means acquires a reference determination value corresponding to the acquired catalyst temperature and correctively reduces the acquired reference determination value based on the acquired catalyst temperature, in accordance with a relationship between the catalyst temperature and the determination value which relationship is predefined such that the reference determination value increases consistently with the catalyst temperature when the catalyst temperature is equal to or higher than a predetermined temperature.

4. The catalyst abnormality diagnosis apparatus according to claim 1 wherein the measurement means measures a stored oxygen amount during lean control and a released oxygen amount during rich control as the oxygen storage capacity, and
the determination means compares a predetermined difference determination value with a difference between the stored oxygen amount and the released oxygen amount or a ratio of the stored oxygen amount to the released oxygen amount to determine whether the catalyst is normal or abnormal based on a result of the comparison.

5. The catalyst abnormality diagnosis apparatus according to claim 4 wherein that the determination value setting means sets the difference determination value based on the acquired catalyst temperature so that a rate of an increase in difference determination value with respect to an increase in catalyst temperature starts increasing at the predetermined temperature.

6. The catalyst abnormality diagnosis apparatus according to claim 5 wherein the determination value setting means sets the difference determination value in accordance with a predefined relationship between the catalyst temperature and the difference determination value.

7. An apparatus configured to diagnose abnormality of a catalyst arranged in an exhaust passage in an internal combustion engine, the apparatus comprising:
active air-fuel ratio control means for performing active air-fuel ratio control such that an air-fuel ratio of exhaust gas supplied to the catalyst is alternately and actively switched between a rich state value and a lean state value;
measurement means for measuring an oxygen storage capacity of the catalyst in conjunction with the performance of the active air-fuel ratio control;
determination means for determining whether the catalyst is normal or abnormal by comparing a value of the oxygen storage capacity measured by the measurement means with a predetermined determination value; and
catalyst temperature acquisition means for acquiring a temperature of the catalyst,
wherein the measurement means measures a stored oxygen amount during lean control and a released oxygen amount during rich control as the oxygen storage capacity, and
when the acquired catalyst temperature acquired by the catalyst temperature acquisition means is equal to or higher than a predetermined temperature, the determination means compares a measured value of the stored oxygen amount with the determination value to determine whether the catalyst is normal or abnormal.

8. The catalyst abnormality diagnosis apparatus according to claim 1 wherein the predetermined temperature is a catalyst temperature at which the measured value of the oxygen storage capacity is greatest.

9. The catalyst abnormality diagnosis apparatus according to claim 1 wherein the predetermined temperature is within a range between about 500° C. and about 650° C.

10. The catalyst abnormality diagnosis apparatus according to claim 7 wherein the predetermined temperature is a catalyst temperature at which the measured value of the oxygen storage capacity is greatest.

11. The catalyst abnormality diagnosis apparatus according to claim 7 wherein the predetermined temperature is within a range between about 500° C. and about 650° C.
